(19) United States
(12) Patent Application Publication
(10) Pub. No.: US 2026/0287030 A1
(43) Pub. Date: Sep. 24, 2026

(54) ROLLER-TYPE CLUTCH

(71) Applicant: TSUBAKIMOTO CHAIN CO., Osaka (JP)

(72) Inventors: Yuji KUREMATSU, Osaka (JP); Yuichiro ISHIKAWA, Osaka (JP)

(73) Assignee: TSUBAKIMOTO CHAIN CO., Osaka (JP)

(21) Appl. No.: 19/561,837

(22) Filed: Mar. 10, 2026

(30) Foreign Application Priority Data
Mar. 24, 2025 (JP) 2025-048190
Jul. 2, 2025 (JP) 2025-112429

(51) Int. Cl. F16D 41/067; F16D 41/08

(52) U.S. Cl. CPC F16D 41/067; F16D 41/088

(57) ABSTRACT

Provided is a roller-type clutch that is capable of realizing reliable engagement, reducing drag torque, and achieving a long service life with a simple structure requiring no adjustment, while enhancing assembly ease, miniaturization, and cost reduction. In order to achieve this, the clutch is configured such that a biasing member that biases a torque-transmitting roller arranged between an inner ring and an outer ring toward one circumferential side is constituted of an annular elastic body, a balance roller or a biasing-force adjusting protrusion serving as a biasing-force adjusting member paired with the torque-transmitting roller is arranged on another circumferential side of the torque-transmitting roller, and the biasing member is wound around the torque-transmitting roller and the biasing-force adjusting member in a crossed manner.

### BACKGROUND OF THE INVENTION

### Field of the Invention

The present invention relates to a roller-type clutch that uses rollers as torque-transmitting members.

### Description of the Related Art

As a clutch for transmitting or interrupting torque from an input-shaft side to an output-shaft side, a roller-type clutch is known in which a plurality of wedge-shaped spaces that narrow toward one circumferential side are formed between an inner ring and an outer ring provided coaxially, and in which cylindrical rollers and a plurality of biasing members that bias the rollers in one circumferential direction are arranged in the respective wedge-shaped spaces (see, e.g., Japanese Patent Application Laid-open No. 2007-255604).

In such a roller-type clutch, for example, when the inner ring rotates in one circumferential direction, the rollers engage both the outer ring and the inner ring, so that the inner ring and the outer ring rotate integrally. On the other hand, for example, when the inner ring rotates in the other circumferential direction, the rollers move to the other circumferential side against the biasing force of the biasing members, so that the rollers do not engage the outer ring and the inner ring, and the inner ring rotates relative to the outer ring.

Furthermore, a roller-type clutch configured to be switchable to an operation mode that permits bi-directional relative rotation of an inner ring and an outer ring is also known (see, e.g., Japanese Patent Application Laid-open No. 2020-046071).

Furthermore, both of the roller-type clutches described in Japanese Patent Application Laid-open Nos. 2007-255604 and 2020-046071 are of an outer-ring-holding type in which the rollers are held on the outer-ring side. However, an inner-ring-holding type in which the rollers are held on the inner-ring side is also known (see, e.g., Japanese Translation of PCT Application No. 2021-523327).

### SUMMARY OF THE INVENTION

Thus, the roller-type clutches described in Japanese Patent Application Laid-open Nos. 2007-255604 and 2020-046071, and Japanese Translation of PCT Application No. 2021-523327 each require a plurality of biasing members corresponding to a plurality of respective rollers, resulting in an increase in the number of components and manufacturing cost, as well as complication of the structure.

Furthermore, as in Japanese Patent Application Laid-open Nos. 2007-255604 and 2020-046071, in the outer-ring-holding roller-type clutches, when the inner ring and the outer ring engage and rotate integrally, a force that moves the rollers toward the expanded side of the wedge-shaped spaces (in the direction in which the interval widens) acts on the rollers due to centrifugal force. When the component of this centrifugal force becomes greater than the biasing force of the biasing members, the rollers no longer engage with the inner ring and the outer ring, and torque transmission between the inner ring and the outer ring becomes impossible. Accordingly, in the outer-ring-holding roller-type clutch, it is necessary to take measures to deal with centrifugal force in order to improve the high-speed rotation performance.

As a measure to deal with centrifugal force, it is conceivable, for example, to increase the biasing force of the biasing means in accordance with the number of rotations of the input shaft or the output shaft. However, such a configuration causes poor wear durability due to an increase in sliding resistance, as well as deterioration of drag torque. In particular, in the roller-type clutch described in Japanese Patent Application Laid-open No. 2020-046071 in which the operation mode is configured to be switchable, a great switching thrust force (select force) is required to switch the operation mode. Therefore, it becomes necessary to take measures to deal with wear of the sliding portion, improve the strength of the selector portion, and increase the thrust of the actuator serving as a selector-driving mechanism, hence, resulting in an increase in size and cost.

As described above, it is actually difficult to apply the outer-ring-holding roller-type clutch to high-speed driving, for example, in an E-Axle in which a one-way clutch is required to exhibit high-speed rotation performance due to enhanced rotational speed of motors.

In the inner-ring-holding roller-type clutch described in Japanese Translation of PCT Application No. 2021-523327, it is possible to maintain a state of engagement between the inner ring and the outer ring even when the centrifugal force increases. However, in a clutch whose operation mode is configured to be switchable, a great switching thrust (select force) is required to switch the operation mode in a state where a great centrifugal force is acting on the rollers. Therefore, even in an inner-ring-holding roller-type clutch, it becomes necessary to take measures to deal with wear of the sliding portion, improve the strength of the selector portion, and increase the thrust of the actuator serving as a selector-driving mechanism, hence, resulting in an increase in size and cost.

The present invention is intended to solve these problems and an object thereof is to provide a roller-type clutch that is capable of realizing reliable engagement, reducing drag torque, and achieving a long service life with a simple structure requiring no adjustment, while enhancing assembly ease, miniaturization, and cost reduction.

In order to solve the above problems, the present invention provides a roller-type clutch including: an inner ring and an outer ring that are provided coaxially so as to be rotatable relative to each other; a plurality of pocket portions each having a wedge-shaped space that narrows toward one circumferential side, the pocket portions being formed between an outer peripheral surface of the inner ring and an inner peripheral surface of the outer ring; a torque-transmitting roller disposed in each of the pocket portions; and a biasing member provided to bias each of the torque-transmitting rollers toward the one circumferential side, wherein the biasing member is constituted of an annular elastic body, a plurality of biasing-force adjusting members respectively corresponding to the torque-transmitting rollers are disposed on another circumferential side of the torque-transmitting rollers so as to form pairs with the torque-transmitting rollers, and the biasing member is wound around the pairs of the torque-transmitting rollers and the biasing-force adjusting members in a crossed manner.

According to the present invention, the biasing member is constituted by an annular elastic body, and the biasing member is configured to be wound around the torque-transmitting rollers and the biasing-force adjusting members arranged on the other circumferential side of the torque-transmitting rollers in a crossed manner. This configuration makes it possible to bias each torque-transmitting roller in one circumferential direction without arranging the biasing member for each of the plurality of torque-transmitting rollers. As a result, it becomes possible to collectively control the movement of the plurality of torque-transmitting rollers using the annular biasing member, and to realize reliable engagement with a simple structure requiring no adjustment, while improving assembly ease, miniaturization, and cost reduction.

The biasing member is configured to be wound around the pairs of the torque-transmitting rollers and the biasing-force adjusting members in a crossed manner at the axial center of the torque-transmitting rollers. This configuration makes it possible to prevent skew (inclination) of the torque-transmitting rollers caused by a bias load of the biasing member acting on the torque-transmitting rollers. As a result, it becomes possible to realize stable engagement and increase the contact areas of the torque-transmitting rollers with the inner ring and the outer ring, thereby improving torque capacity. Furthermore, even without increasing the biasing force of the biasing member, it becomes possible to realize stable engagement during high-speed rotation and reduce the influence of centrifugal force. In addition, because the torque-transmitting rollers can have a symmetrical shape, it becomes possible to prevent erroneous assembly of the torque-transmitting rollers.

Furthermore, axial displacement of the torque-transmitting rollers is configured to be restricted by flange members fixed to the respective ends of the outer ring. This configuration facilitates the manufacturing of the outer ring and reduces the axial dimension thereof. As a result, it becomes possible to facilitate a reduction in size and simplification of the structure of the roller-type clutch, while improving the assembly efficiency of the torque-transmitting rollers and the biasing member.

Furthermore, the biasing-force adjusting members are constituted of balance rollers movable in the circumferential direction, and the centrifugal force acting on the balance rollers is configured to be greater than that acting on the torque-transmitting rollers. This configuration makes it possible to apply a load to the torque-transmitting rollers toward one circumferential side by the action of centrifugal force exerted on the balance rollers. Therefore, even without increasing the biasing force of the biasing member, it becomes possible to realize stable engagement during high-speed rotation and perform torque transmission between the inner ring and the outer ring. Furthermore, it becomes possible to suppress wear and reduce drag torque, thereby achieving a long service life.

The balance rollers are configured to have the same size and the same weight as the torque-transmitting rollers. This configuration makes it possible to make the roller-type clutch structurally well-balanced.

Moreover, the biasing-force adjusting members are constituted of protrusions integrally provided on the inner ring or the outer ring. This configuration makes it possible to reduce the number of components, thereby reducing the cost, and to facilitate a reduction in size and simplification of the structure.

Moreover, the operation mode is configured to be switchable by the selector. This configuration makes it possible to minimize the select force in both low-speed rotation and high-speed rotation. As a result, it becomes possible to reduce wear of the selector and reduce the strength required for the selector. Furthermore, because an actuator with a small thrust can be used as a selector-driving mechanism, it becomes possible to facilitate a reduction in size and cost.

### BRIEF DESCRIPTION OF THE DRAWINGS

FIG. 1 is an exploded perspective view illustrating a configuration example of a roller-type clutch according to a first embodiment of the present invention;

FIG. 2 is a partially cutaway perspective view of the roller-type clutch illustrated in FIG. 1;

FIG. 3 is a cross-sectional view of the roller-type clutch illustrated in FIG. 1, taken along a plane perpendicular to the rotation axis;

FIG. 4 is a partially cross-sectional view of the roller-type clutch illustrated in FIG. 1, taken along a plane parallel to the rotation axis;

FIG. 5 is a perspective view illustrating the configuration of the outer ring of the roller-type clutch illustrated in FIG. 1;

FIG. 6 is a perspective view illustrating the configuration of the selector of the roller-type clutch illustrated in FIG. 1;

FIG. 7 is a schematic view of a portion of the roller-type clutch illustrated in FIG. 1, as viewed from the radially outward side;

FIG. 8A is a schematic view illustrating the configuration of an essential portion of the roller-type clutch illustrated in FIG. 1 when an operation mode is set to a lock mode;

FIG. 8B is a schematic view illustrating the states of a torque-transmitting roller and a balance roller during high-speed rotation;

FIG. 9A is a schematic view of a portion of the roller-type clutch illustrated in FIG. 1, as viewed from the radially outward side when the operation mode is switched to a bi-directional free mode;

FIG. 9B is a schematic view illustrating the configuration of an essential portion of the roller-type clutch illustrated in FIG. 1 when the operation mode is set to the bi-directional free mode;

FIG. 10 is a partially cutaway perspective view illustrating another configuration example of the roller-type clutch according to the first embodiment of the present invention;

FIG. 11 is a partially cross-sectional view of the roller-type clutch illustrated in FIG. 10, taken along a plane parallel to the rotation axis;

FIG. 12 is a schematic view of a portion of the roller-type clutch illustrated in FIG. 10, as viewed from the radially outward side;

FIG. 13 is a perspective view illustrating the configuration of the outer ring of the roller-type clutch illustrated in FIG. 10;

FIG. 14 is a partially cross-sectional view illustrating still another configuration example of the roller-type clutch according to the first embodiment of the present invention, taken along a plane parallel to the rotation axis;

FIG. 15 is a schematic view of a portion of the roller-type clutch illustrated in FIG. 14, as viewed from the radially outward side;

FIG. 16 is a perspective view illustrating the configuration of the outer ring of the roller-type clutch illustrated in FIG. 14;

FIG. 17 is a partially cutaway perspective view illustrating a configuration example of the roller-type clutch according to a second embodiment of the present invention;

FIG. 18 is a cross-sectional view of the roller-type clutch illustrated in FIG. 17, taken along a plane perpendicular to the rotation axis;

FIG. 19 is a perspective view illustrating the configuration of the outer ring of the roller-type clutch illustrated in FIG. 17;

FIG. 20A is a schematic view illustrating the configuration of an essential portion of the roller-type clutch illustrated in FIG. 17 when the operation mode is set to the lock mode; and

FIG. 20B is a schematic view illustrating the configuration of an essential portion of the roller-type clutch illustrated in FIG. 17 when the operation mode is set to the bi-directional free mode.

### DESCRIPTION OF THE PREFERRED EMBODIMENTS

### First Embodiment

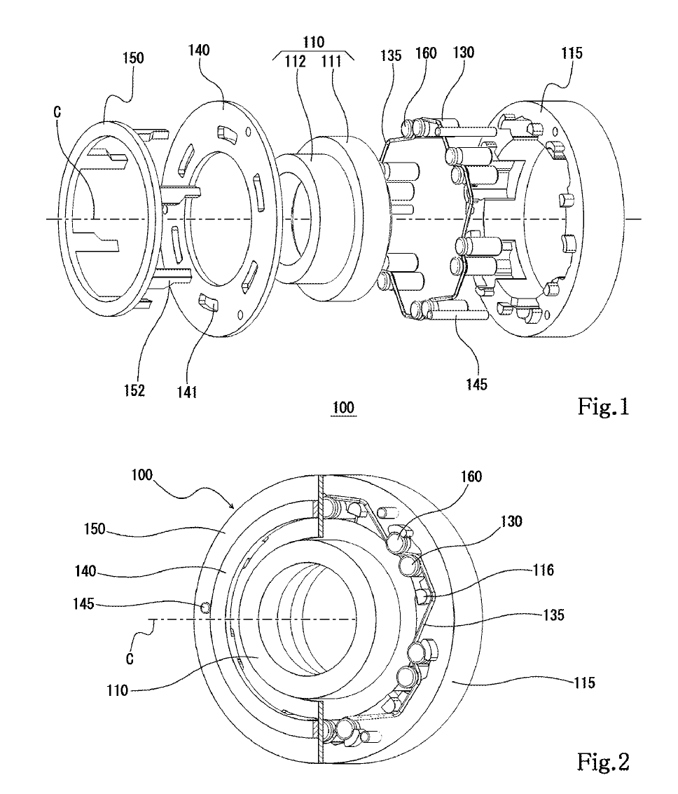

As illustrated in FIGS. 1 to 4, a roller-type clutch 100 according to a first embodiment includes an inner ring 110, an outer ring 115, a plurality of torque-transmitting rollers 130, a biasing member 135, a flange member 140, and a selector 150. In FIGS. 1 to 4, C indicates a rotation axis.

The inner ring 110 and the outer ring 115 are provided coaxially so as to be rotatable relative to each other, with the outer peripheral surface of the inner ring 110 and the inner peripheral surface of the outer ring 115 disposed adjacent to and facing each other, thereby making it possible to suppress eccentricity of the inner ring 110 and the outer ring 115.

Between the outer peripheral surface of the inner ring 110 and the inner peripheral surface of the outer ring 115, a plurality of pocket portions 120 are formed at positions spaced at specified intervals in the circumferential direction. In this embodiment, the outer peripheral surface of the inner ring 110 has a cylindrical shape about the rotation axis C, and the pocket portions 120 are formed at the inner circumferential edge of the outer ring 115.

The inner ring 110 is made, for example, of sintered metal (including one impregnated with a lubricant) or a steel material, and has a large-diameter cylindrical portion 111 whose outer peripheral surface constitutes a surface (engaging surface) that comes in contact with the torque-transmitting rollers 130, and a small-diameter cylindrical portion 112 that is continuous with one axial end of the large-diameter cylindrical portion 111.

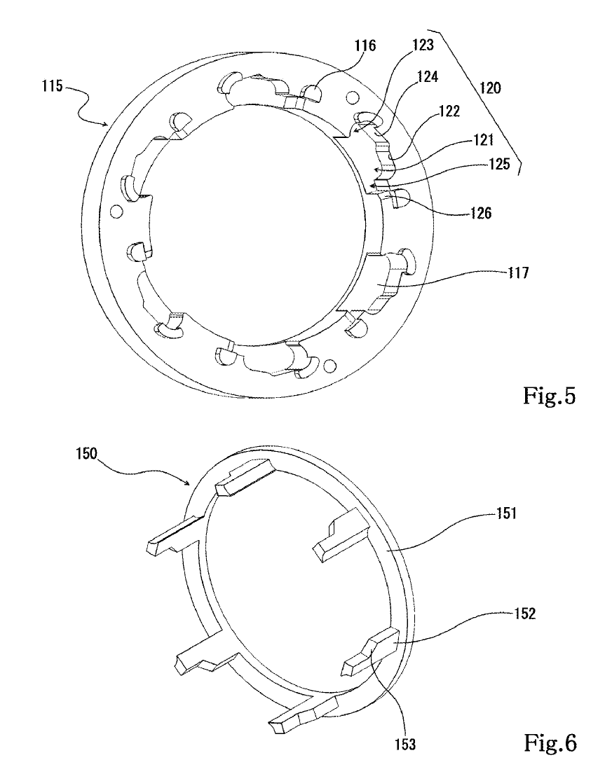

The outer ring 115 is made, for example, of sintered metal (including one impregnated with a lubricant) or a steel material, and is configured such that the pocket portions 120 are formed at the inner circumferential edge of one axial end surface of a cylindrical base material, as illustrated in FIG. 5. The pocket portions 120 are configured by forming recessed portions in such a manner that an end wall 117 remains on the other axial end side of the outer ring 115.

The pocket portions 120 each have a wedge-shaped space 121 that narrows toward one circumferential side, and a roller-holding space 123 that is continuous with the other circumferential side of the wedge-shaped space 121. The wedge-shaped space 121 has a cam surface 122 that slopes inward in the radial direction toward one circumferential side. The roller-holding space 123 has a roller-restricting surface 124 that slopes outward in the radial direction toward one circumferential side.

Furthermore, a roller-pressing-portion accommodation space 125, which can accommodate a roller-pressing portion 152 of the selector 150 that forcibly moves the torque-transmitting roller 130 in the circumferential direction, is continuous with one circumferential side of the wedge-shaped space 121. The opening surface of the wall portion on one circumferential side, which defines the roller-pressing-portion accommodation space 125, is formed as a tapered surface 126 that slopes toward the other circumferential side in the direction of the other axial end.

Reference numeral 116 in FIG. 5 indicates a biasing-member supporting protrusion, which is provided at a position on one circumferential side of each pocket portion 120 on one axial end surface of the outer ring 115.

Each of the plurality of torque-transmitting rollers 130 is made, for example, of steel and is configured such that, when accommodated in the pocket portion 120, it protrudes axially outward from one end surface of the outer ring 115. A biasing-member attachment groove 131 is formed on the circumferential surface of the portion of the torque-transmitting roller 130 that protrudes from one end surface of the outer ring 115, the groove extending over the entire circumference.

As illustrated in FIG. 4, the axial movement of each of the plurality of torque-transmitting rollers 130 is restricted by the end wall 117 on the other axial end side of the pocket portion 120 and by the flange member 140.

The biasing member 135 is common to each of the plurality of torque-transmitting rollers 130 and is constituted by an annular elastic body. In the present embodiment, a garter spring is used, for example, as the biasing member 135.

The biasing member 135 is wound around the biasing-member attachment grooves 131 of the respective torque-transmitting rollers 130 and the biasing-member supporting protrusions 116 of the outer ring 115.

The flange member 140 is, for example, an annular plate made of sheet metal, is positioned on one axial end side of the outer ring 115 coaxially with the inner ring 110 and the outer ring 115 with the small-diameter cylindrical portion 112 of the inner ring 110 inserted therethrough, and is fixed to the outer ring 115 by pin members 145.

The flange member 140 has, at its positions facing the respective roller-pressing-portion accommodation spaces 125 in the outer ring 115, a plurality of through-holes 141 that are configured to allow insertion of the roller-pressing portions 152 of the selector 150 and axially extend through the thickness.

The selector 150 is configured to be capable of switching the operation mode between a one-way lock mode in which the relative rotation of the inner ring 110 and the outer ring 115 in one circumferential direction is restricted and a bidirectional free mode in which the relative rotation of the inner ring 110 and the outer ring 115 in both circumferential directions is permitted.

In the present embodiment, the selector 150 is configured to be axially movable by an actuator (not illustrated) independently of the rotational operations of the inner ring 110 and the outer ring 115. For example, when switching the operation mode from the one-way lock mode to the bidirectional free mode, the torque-transmitting rollers 130 are forcibly moved toward the other circumferential side so that the torque-transmitting rollers 130 can be maintained in a floating state with respect to the inner ring 110 and the outer ring 115.

The selector 150 is made, for example, of sheet metal, sintered metal, or a steel material and includes, as illustrated in FIG. 6, an annular-plate-shaped base portion 151 and a plurality of roller-pressing portions 152 corresponding to the plurality of torque-transmitting rollers 130, respectively.

Each roller-pressing portion 152 is constituted by a column-shaped body integrally provided so as to extend toward the other axial end side on the other surface of the base portion 151, and has a tapered part 153 that becomes gradually narrow toward its tip end side. The tapered part 153 is formed such that the lateral surface on one circumferential side extends inclined to the other circumferential side as it extends toward the other axial end side.

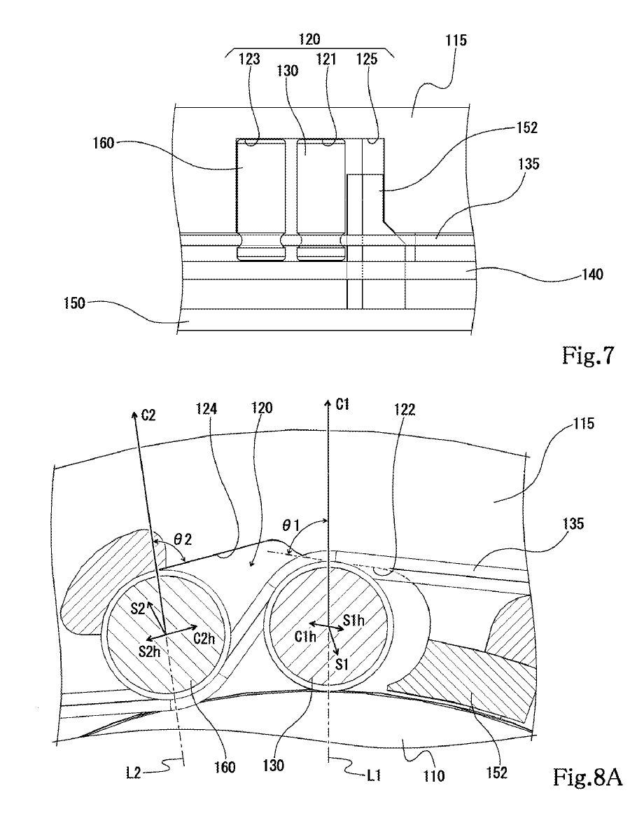

As illustrated in FIG. 7, each of the plurality of roller-pressing portions 152 is inserted into the through-hole 141 formed in the flange member 140, and its tip-end-side part is located within the roller-pressing-portion accommodation space 125.

Thus, in the roller-type clutch 100 according to the present embodiment, balance rollers 160, which serve as a plurality of biasing-force adjusting members corresponding to the plurality of torque-transmitting rollers 130, respectively, are arranged on the other circumferential side of the torque-transmitting rollers 130 so as to form pairs with the torque-transmitting rollers 130.

Each of the plurality of balance rollers 160 is made, for example, of steel and is configured such that, when accommodated in the pocket portion 120, it protrudes axially outward from one end surface of the outer ring 115 as illustrated in FIG. 7. A biasing-member attachment groove 161 is formed on the circumferential surface of the portion of the balance roller 160 that protrudes from the one end surface of the outer ring 115, the groove extending over the entire circumference.

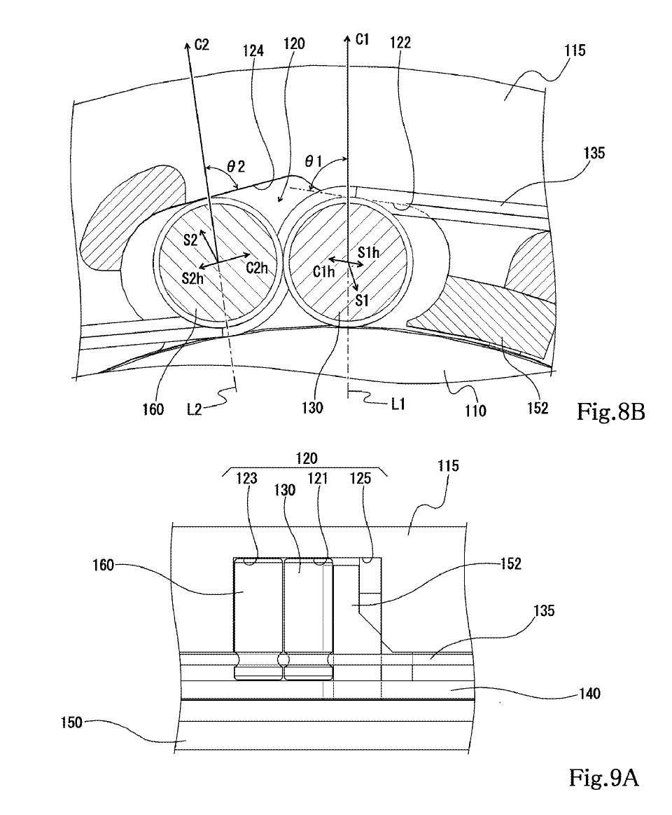

As illustrated in FIG. 8A, the biasing member 135 is wound around a pair of the torque-transmitting roller 130 and the balance roller 160 in a crossed manner, with its inner periphery in contact with the torque-transmitting roller 130 and its outer periphery in contact with the balance roller 160.

As a result, a biasing force S1 of the biasing member 135 acts on the torque-transmitting roller 130 toward the inner ring, and the torque-transmitting roller 130 is biased toward one circumferential side (engaging direction) by a component S1h along the cam surface 122 of the wedge-shaped space 121.

On the other hand, a biasing force S2 of the biasing member 135 acts on the balance roller 160 toward the outer ring, and the balance roller 160 is held biased toward the other circumferential side by a component S2h along the roller-restricting surface 124 of the roller-holding space 123.

The roller-type clutch 100 according to the present embodiment is configured such that, when the inner ring 110 and the outer ring 115 engage with each other and rotate integrally, a component C2h along the roller-restricting surface 124 of a centrifugal force C2 acting on the balance roller 160 becomes greater than a component C1h along the cam surface 122 of a centrifugal force C1 acting on the torque-transmitting roller 130.

The magnitude of the centrifugal force acting on the balance roller 160 can be adjusted by appropriately changing an angle θ2, which is formed between a line L2 connecting the rotation axis C and the center of the balance roller 160 in a cross section perpendicular to the rotation axis and the roller-restricting surface 124 in the pocket portion 120, the weight of the balance roller 160, or the overlap (winding angle) of the biasing member 135 with respect to the balance roller 160.

In the present embodiment, the balance roller 160 has the same configuration as the torque-transmitting roller 130. That is, the balance roller 160 and the torque-transmitting roller 130 have the same size (shape) and the same weight. As a result, the roller-type clutch 100 can be structurally well-balanced. Furthermore, the overlap of the biasing member 135 with respect to the balance roller 160 is substantially the same as that of the biasing member 135 with respect to the torque-transmitting roller 130. That is, the biasing force S1 of the biasing member 135 acting on the torque-transmitting roller 130 and the biasing force S2 of the biasing member 135 acting on the balance roller 160 are configured to be substantially the same in magnitude. Accordingly, by configuring an angle θ2, which is formed between a line L2 connecting the rotation axis C and the center of the balance roller 160 and the roller-restricting surface 124 in the pocket portion 120, to become greater than an angle θ1, which is formed between a line L1 connecting the rotation axis C and the center of the torque-transmitting roller 130 and the cam surface 122 in the pocket portion 120, the component C2h of the centrifugal force acting on the balance roller 160 is configured to become greater than the component C1h of the centrifugal force acting on the torque-transmitting roller 130.

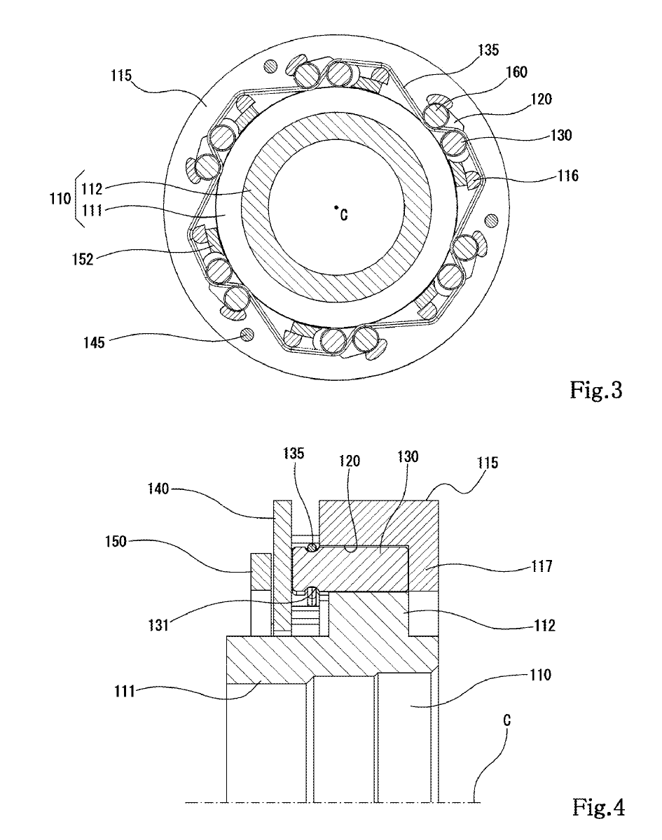

In the roller-type clutch 100 according to the present embodiment, when the operation mode is set to the lock mode, the torque-transmitting rollers 130 engage the inner ring 110 and the outer ring 115 so as to transmit torque therebetween when the inner ring 110 is rotated in one circumferential direction (clockwise in FIG. 3) or when the outer ring 115 is rotated in the other circumferential direction (counterclockwise in FIG. 3). On the other hand, when the inner ring 110 is rotated in the other circumferential direction or when the outer ring 115 is rotated in the one circumferential direction, the torque-transmitting rollers 130 do not engage the inner ring 110 and the outer ring 115, and one of the inner ring 110 and the outer ring 115 rotates idly relative to the other.

When the inner ring 110 and the outer ring 115 engage with each other and rotate integrally, and when the component C1h of the centrifugal force acting on the torque-transmitting roller 130 is smaller than the component S1h of the biasing force of the biasing member 135 acting on the torque-transmitting roller 130, a state in which the balance roller 160 is held and secured in the roller-holding space 123 in the pocket portion 120 is maintained. As a result, the torque-transmitting roller 130 can be biased toward one circumferential side with an appropriate biasing force by the biasing member 135, thereby making it possible to exhibit a desired clutch function.

Furthermore, during high-speed rotation in which the component C1h of the centrifugal force acting on the torque-transmitting roller 130 becomes greater than the component S1h of the biasing force of the biasing member 135 acting on the torque-transmitting roller 130, the torque-transmitting roller 130 moves toward the other circumferential side along the cam surface 122, while the balance roller 160 moves toward the one circumferential side along the roller-restricting surface 124. However, because the component C2h of the centrifugal force acting on the balance roller 160 is configured to become greater than the component C1h of the centrifugal force acting on the torque-transmitting roller 130, the balance roller 160 starts to move in the circumferential direction ahead of the torque-transmitting roller 130 and applies a load to the torque-transmitting roller 130 in the one circumferential direction as illustrated in FIG. 8B. Therefore, even in the outer-ring-holding roller-type clutch 100 in which the torque-transmitting rollers 130 are held on the outer-ring side, it is possible to maintain a state in which the torque-transmitting rollers 130 remain engaged with the inner ring 110 and the outer ring 115, even when a large centrifugal force acts during high-speed rotation.

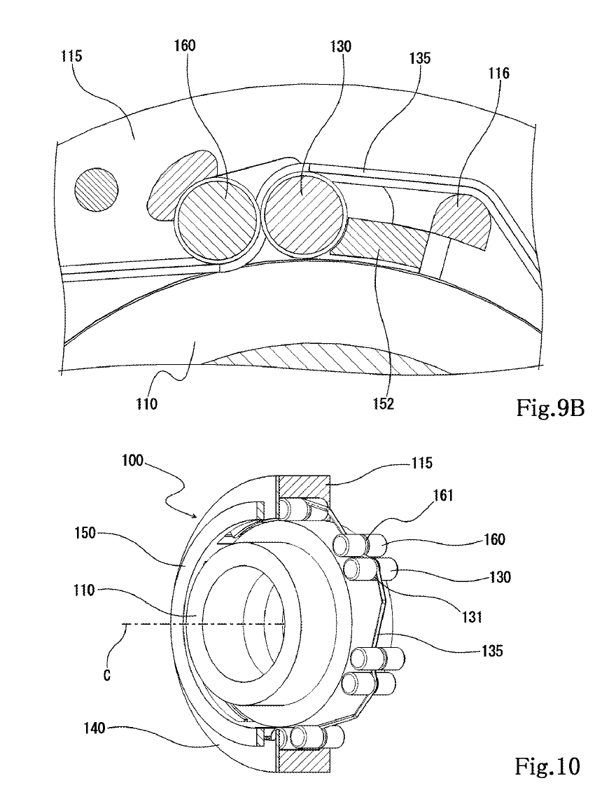

Furthermore, in the roller-type clutch 100 according to the present embodiment, the operation mode can be switched by moving the selector 150 in the axial direction. When switching the operation mode from the lock mode (e.g., the state illustrated in FIG. 7) to the bidirectional free mode, the proximal end of the roller-pressing portion 152 of the selector 150 enters the roller-pressing-portion accommodation space 125 by moving the selector 150 toward the other axial end side as illustrated in FIG. 9A, thereby forcibly moving the torque-transmitting roller 130 toward the other circumferential side. As a result, as illustrated in FIG. 9B, the torque-transmitting roller 130 is held in a floating state with respect to the inner ring 110 and the outer ring 115, and one of the inner ring 110 and the outer ring 115 rotates idly in both circumferential directions with respect to the other.

As described above, in the roller-type clutch 100 according to the present embodiment, the biasing member 135 is constituted by an annular elastic body, and the biasing force applied to the torque-transmitting rollers 130 is configured to be adjustable by the balance rollers 160. This configuration makes it possible to collectively control the movement of all the torque-transmitting rollers 130. As a result, regardless of the magnitude of the centrifugal force acting on the torque-transmitting rollers 130, it becomes possible to realize reliable engagement and minimize drag torque and wear during both low-speed rotation and high-speed rotation.

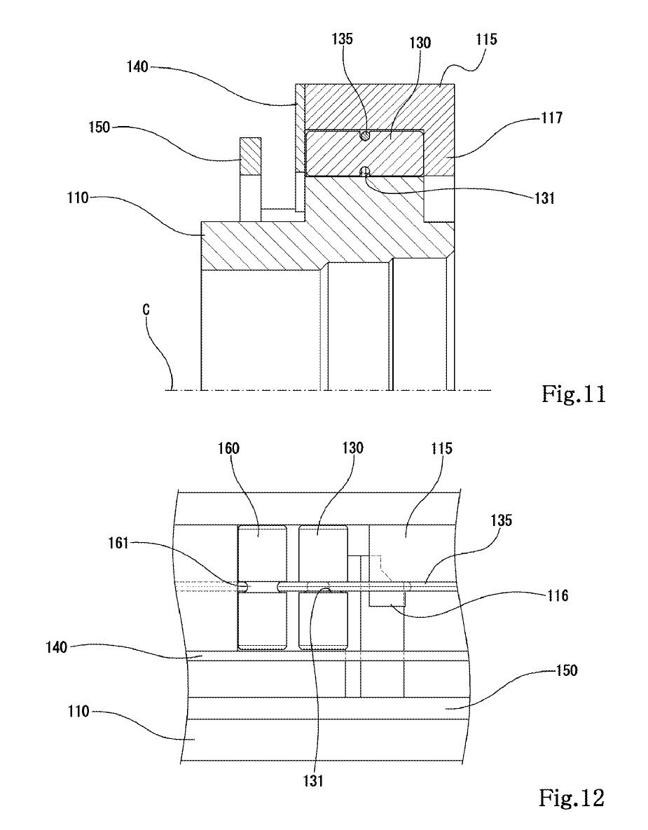

In the above-described embodiment, the biasing member 135 is wound around one axial end portion of each of the torque-transmitting rollers 130 and the balance rollers 160. However, as illustrated in FIGS. 10 to 12, the biasing member 135 may instead be configured to be wound around the pairs of the torque-transmitting rollers 130 and the balance rollers 160 in a crossed manner at the respective axial center.

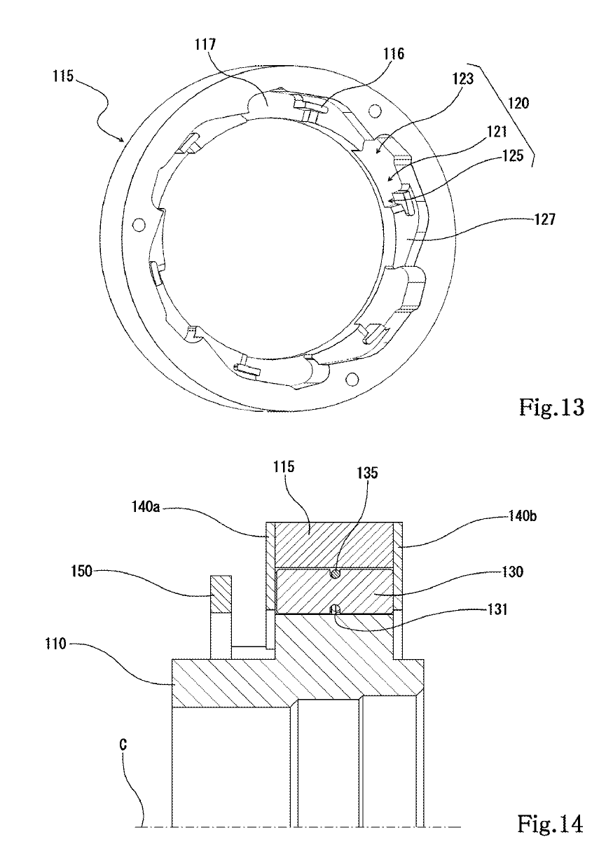

In the roller-type clutch 100 according to the present embodiment, as shown in FIG. 13, the outer ring 115 is configured such that recessed portions each including the pocket portion 120 and the biasing-member arrangement space 127 are formed at the inner circumferential edge portion of one axial end surface of the cylindrical base material in such a manner that the end wall 117 remains on the other axial end side of the outer ring 115. The pocket portions 120 have the same configuration as the pocket portions 120 of the outer ring 115 of the roller-type clutch 100 illustrated in FIG. 1 and each include the wedge-shaped space 121, the roller-holding space 123, and the roller-pressing-portion accommodation space 125.

In the outer ring 115 according to the present embodiment, the biasing-member supporting protrusions 116 are provided, within the recessed portions, at positions radially outward of the roller-pressing-portion accommodation spaces 125, and are configured to have their one axial end surface formed as a flat surface. Furthermore, the spaces between the adjacent pocket portions 120 serve as the biasing-member arrangement spaces 127.

Each of the torque-transmitting rollers 130 and the balance rollers 160 has the biasing-member attachment groove 131 or 161 that extends over the entire circumference at the center in the axial direction, and the biasing member 135 is wound around the pairs of the torque-transmitting rollers 130 and the balance rollers 160 in a crossed manner such that its inner periphery is in contact with the torque-transmitting rollers 130 and its outer periphery is in contact with the balance rollers 160.

In the present embodiment, each of the torque-transmitting rollers 130 and the balance rollers 160 is arranged within the pocket portion 120 such that it does not protrude axially outward from one end surface of the outer ring 115, with its other axial end surface in contact with the end wall 117 on the other axial end side of the outer ring 115.

The annular plate-shaped flange member 140 is fixed to the one end surface of the outer ring 115 in a contacting state, thereby restricting relative axial displacement of the torque-transmitting rollers 130 and the balance rollers 160.

The biasing member 135 is configured to be wound around the pairs of the torque-transmitting rollers 130 and the balance rollers 160 in a crossed manner at the axial center of the torque-transmitting rollers. This configuration makes it possible to prevent skew (inclination) of the torque-transmitting rollers 130 caused by a bias load of the biasing member 135 acting on the torque-transmitting rollers 130. As a result, it becomes possible to realize stable engagement and increase the contact areas of the torque-transmitting rollers 130 with the inner ring 110 and the outer ring 115, thereby improving torque capacity.

Furthermore, even without increasing the biasing force of the biasing member 135, it becomes possible to realize stable engagement during high-speed rotation and reduce the influence of centrifugal force. In addition, because the torque-transmitting rollers 130 can be configured to have a symmetrical shape, it becomes possible to prevent erroneous assembly of the torque-transmitting rollers 130.

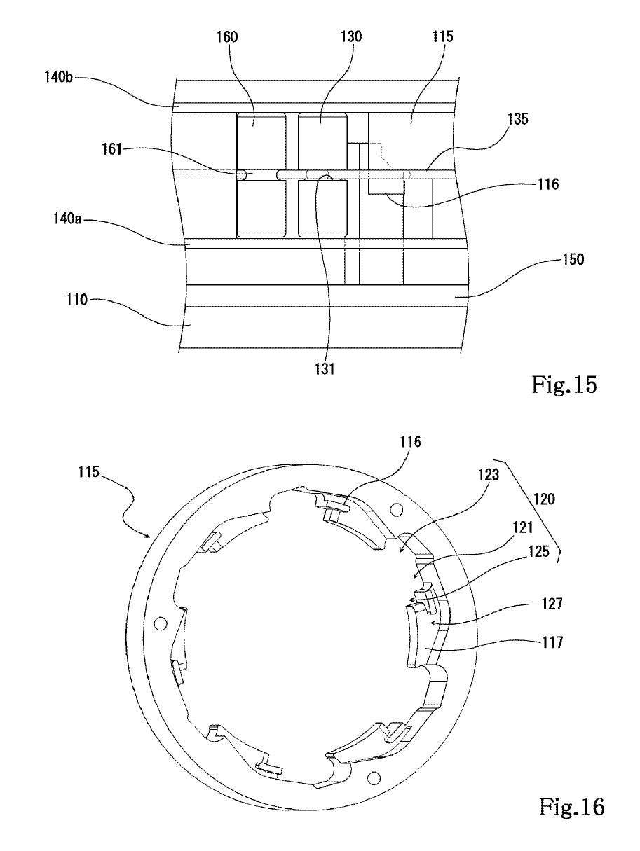

In the above configuration, the relative axial displacement of the torque-transmitting rollers 130 and the balance rollers 160 is restricted by the end wall 117 on the other axial end side of the outer ring 115 and by the flange member 140. However, as illustrated in FIGS. 14 and 15, a flange member 140a on one end side and a flange member 140b on the other end side may instead be provided on both ends of the outer ring 115 to restrict the relative axial displacement of the torque-transmitting rollers 130 and the balance rollers 160.

In the roller-type clutch 100 according to the present embodiment, the outer ring 115 is configured such that, as illustrated in FIG. 16, the pocket portions 120 and the biasing-member arrangement spaces 127 are formed at the inner circumferential edge portion of one axial end surface of the cylindrical base material. The pocket portions 120 each have the wedge-shaped space 121, the roller-holding space 123, and the roller-pressing-portion accommodation space 125, and are formed to extend through the thickness such that the other axial end surface of each of the torque-transmitting rollers 130 and the balance rollers 160 is exposed to the outside. The biasing-member arrangement spaces 127 are configured by forming recessed portions in such a manner that the end wall 117 remains on the other axial end side of the outer ring 115. The biasing-member supporting protrusions 116 are provided at positions radially outward of the roller-pressing-portion accommodation spaces 125 on the end wall 117, whereby both axial end surfaces of the outer ring 115 are constituted by flat surfaces.

In the present embodiment, each of the torque-transmitting rollers 130 and the balance rollers 160 is arranged such that it does not protrude axially outward from one end surface and the other end surface of the outer ring 115.

Each of the torque-transmitting rollers 130 and the balance rollers 160 has the biasing-member attachment groove 131 or 161 that extends over the entire circumference at the center in the axial direction.

The biasing member 135 is wound around the pairs of the torque-transmitting rollers 130 and the balance rollers 160 in a crossed manner, with its inner periphery in contact with the torque-transmitting rollers 130 and its outer periphery in contact with the balance rollers 160.

In the present embodiment, the annular plate-shaped flange member 140a on one end side and the annular plate-shaped flange member 140b on the other end side are fixed to one end surface and the other end surface of the outer ring 115, respectively, in a contacting state, thereby restricting the relative axial displacement of the torque-transmitting rollers 130 and the balance rollers 160.

As in the present embodiment, the axial displacement of the torque-transmitting rollers 130 is configured to be restricted by the flange member 140a on one end side and the flange member 140b on the other end side, which are fixed to the respective ends of the outer ring 115. This configuration facilitates the manufacturing of the outer ring 115 and reduces the axial dimension thereof. As a result, it becomes possible to facilitate a reduction in size and simplification of the structure of the roller-type clutch 100, while improving the assembly efficiency of the torque-transmitting rollers 130 and the biasing members 135.

### Second Embodiment

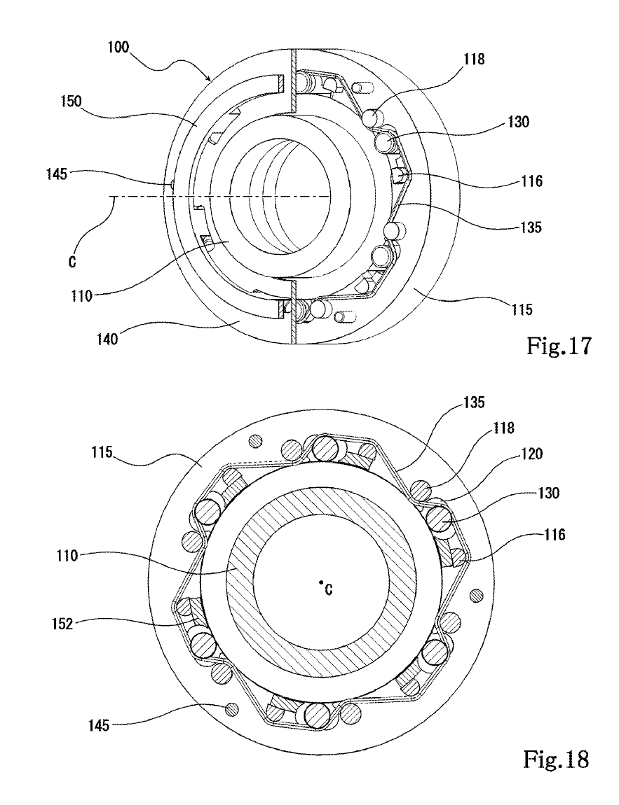

As illustrated in FIGS. 17 and 18, the roller-type clutch 100 according to a second embodiment of the present invention has the same configuration as the roller-type clutch 100 according to the first embodiment, except for the configuration of the biasing-force adjusting members. In FIGS. 17 and 18, the same components as those of the roller-type clutch 100 according to the first embodiment are indicated by the same reference numerals, and their description will be omitted.

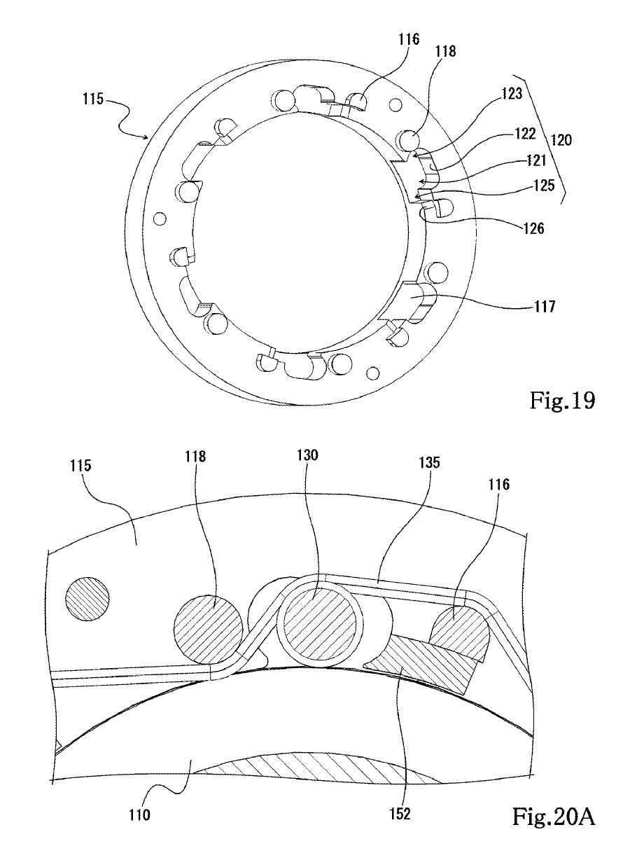

As illustrated in FIG. 19, in the outer ring 115 of this embodiment, cylindrical biasing-force adjusting protrusions 118, which serve as the biasing-force adjusting members paired with the torque-transmitting rollers 130, are provided at positions on the other circumferential side of the respective pocket portions 120 on one axial end surface.

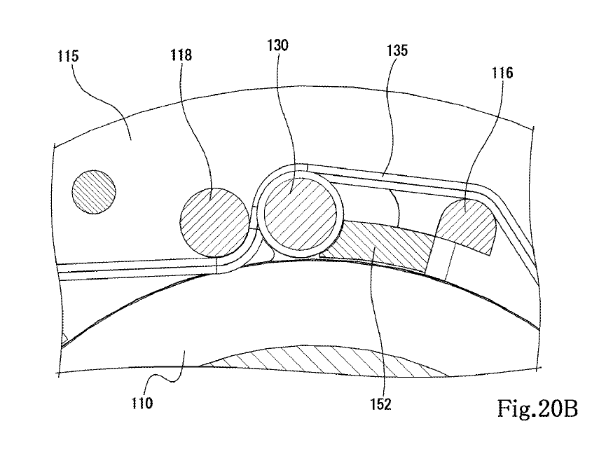

As illustrated in FIG. 20A, the biasing member 135 is wound around the torque-transmitting roller 130, the biasing-member supporting protrusion 116, and the biasing-force adjusting protrusion 118 such that it crosses between a pairs of the torque-transmitting roller 130 and the biasing-force adjusting protrusion 118. As a result, the component of the biasing force of the biasing member 135 along the cam surface 122 defining the wedge-shaped space 121 acts on the torque-transmitting roller 130, thereby biasing the torque-transmitting roller 130 toward one circumferential side.

In the roller-type clutch 100 according to the present embodiment as well, when the operation mode is set to the lock mode, the torque-transmitting rollers 130 engage the inner ring 110 and the outer ring 115 so as to transmit torque therebetween when the inner ring 110 is rotated in one circumferential direction (clockwise in FIG. 20A) or when the outer ring 115 is rotated in the other circumferential direction (counterclockwise in FIG. 20A). On the other hand, when the inner ring 110 is rotated in the other circumferential direction or when the outer ring 115 is rotated in the one circumferential direction, the torque-transmitting rollers 130 do not engage the inner ring 110 and the outer ring 115, and one of the inner ring 110 and the outer ring 115 rotates idly relative to the other.

Furthermore, the operation mode can be switched by moving the selector 150 in the axial direction. When switching the operation mode from the lock mode (e.g., the state illustrated in FIG. 20A) to the bidirectional free mode, the proximal ends of the roller-pressing portions 152 of the selector 150 enter the roller-pressing-portion accommodation spaces 125 by moving the selector 150 toward the other axial end side, thereby forcibly moving the torque-transmitting rollers 130 toward the other circumferential side. As a result, as illustrated in FIG. 20B, the torque-transmitting roller 130 is held in a floating state with respect to the inner ring 110 and the outer ring 115, and one of the inner ring 110 and the outer ring 115 rotates idly in both circumferential directions with respect to the other.

In the roller-type clutch 100 according to the present embodiment, by adjusting the overlap of the biasing member 135 with respect to the torque-transmitting rollers 130 using the biasing-force adjusting protrusions 118, it becomes possible to bias the respective torque-transmitting rollers 130 in one circumferential direction and collectively control the movement of the plurality of torque-transmitting rollers 130 with the annular biasing member 135, without arranging the biasing member 135 for each of the plurality of torque-transmitting rollers 130. As a result, it becomes possible to realize reliable engagement with a simple structure requiring no adjustment, while improving assembly ease, miniaturization, and cost reduction.

The embodiments of the present invention have been described above, but the present invention is not limited to the above configurations.

For example, although the operation mode is configured to be switchable by the selector in the above embodiments, the roller-type clutch may be configured to operate as a normal one-way clutch.

Furthermore, although the outer-ring-holding roller-type clutch has been described in the above embodiments, an inner-ring-holding roller-type clutch may instead be used. In such a clutch, the biasing-force adjusting members are constituted by the balance rollers, and the centrifugal force acting on the balance rollers is configured to become greater than that acting on the torque-transmitting rollers. This configuration can prevent excessive engagement force due to centrifugal force during high-speed rotation. As a result, it becomes possible to reduce the surface pressure of the outer ring and the select force, thereby transmitting torque between the inner ring and the outer ring. Furthermore, it becomes possible to suppress wear and reduce drag torque, thereby achieving a long service life.

Moreover, in the above-described first embodiment, the angle formed between the line connecting the rotation axis and the center of the balance roller and the roller-restricting surface in the pocket portion is configured to become greater than the angle formed between the line connecting the rotation axis and the center of the torque-transmitting roller and the cam surface in the pocket portion. However, depending on the size and weight of the balance roller, the component of the centrifugal force acting on the balance roller may instead be configured to become greater than the component of the centrifugal force acting on the torque-transmitting roller.

Moreover, in the above-described second embodiment as well, the biasing member may be configured to be wound around the pairs of the torque-transmitting rollers and the biasing-force adjusting protrusions in a crossed manner at the axial center of the torque-transmitting rollers. Furthermore, the flange member on one end side and the flange member on the other end side may be configured to be provided on the respective ends of the outer ring to restrict axial displacement of the torque-transmitting rollers.

Moreover, regarding the basic configuration of the roller-type clutch in the above-described embodiments, the contact surface (cam surface) of the torque-transmitting roller that defines the wedge-shaped space is formed as a flat inclined surface, but it may instead be formed as a free curved surface.

Furthermore, the biasing member is not limited to a garter spring and may instead be an annular elastic body.

Moreover, the outer ring and the inner ring may be unitized integrally with other components such as a gear and a shaft.

Moreover, although the flange member is configured to be fixed to the outer ring by press-fitting or caulking pin members in the above-described embodiments, it may instead be fixed by fastening members such as bolts.

What is claimed is:

1. A roller-type clutch comprising: an inner ring and an outer ring that are provided coaxially so as to be rotatable relative to each other; a plurality of pocket portions each having a wedge-shaped space that narrows toward one circumferential side, the pocket portions being formed between an outer peripheral surface of the inner ring and an inner peripheral surface of the outer ring; a torque-transmitting roller disposed in each of the pocket portions; and a biasing member provided to bias each of the torque-transmitting rollers toward the one circumferential side, wherein
the biasing member is constituted of an annular elastic body,
a plurality of biasing-force adjusting members respectively corresponding to the torque-transmitting rollers are disposed on another circumferential side of the torque-transmitting rollers so as to form pairs with the torque-transmitting rollers, and
the biasing member is wound around the pairs of the torque-transmitting rollers and the biasing-force adjusting members in a crossed manner.

2. The roller-type clutch according to claim 1, wherein
the biasing member is wound around the pairs of the torque-transmitting rollers and the biasing-force adjusting members in a crossed manner at an axial center of the torque-transmitting rollers.

3. The roller-type clutch according to claim 1, wherein flange members that restrict axial displacement of the torque-transmitting rollers are fixed on both axial sides of the outer ring.

4. The roller-type clutch according to claim 1, wherein the biasing-force adjusting members are constituted of balance rollers,
the balance rollers are disposed within the pocket portions, and
an angle in a cross section perpendicular to a rotation axis, the angle being formed between a line, which connects the rotation axis and a center of each of the balance rollers, and a roller-restricting surface in each of the pocket portions, a weight of each of the balance rollers, or an overlap of the biasing member with respect to each of the balance rollers is configured such that a centrifugal force acting on each of the balance rollers becomes greater than a centrifugal force acting on each of the torque-transmitting rollers.

5. The roller-type clutch according to claim 4, wherein the balance rollers have same size and same weight as the torque-transmitting rollers.

6. The roller-type clutch according to claim 1, wherein the biasing-force adjusting members are constituted of cylindrical protrusions provided on the inner ring or the outer ring.

7. The roller-type clutch according to claim 1, comprising a selector configured to switch an operation mode between a one-way lock mode in which relative rotation of the inner ring and the outer ring in one circumferential direction is restricted, and a bidirectional free mode in which relative rotation of the inner ring and the outer ring in both circumferential directions is permitted, wherein,
the selector is configured, when switching the operation mode from the one-way lock mode to the bidirectional free mode, to forcibly move the torque-transmitting rollers toward the other circumferential side so as to maintain the torque-transmitting rollers in a floating state with respect to the inner ring and the outer ring.
